(19) United States
(12) Patent Application Publication
(10) Pub. No.: US 2002/0143924 A1
(43) Pub. Date: Oct. 3, 2002

(54) Printer, control method, and computer readable recording medium which stores printer control program

(75) Inventor: Kenji Iga, Kawasaki (JP)

Correspondence Address: ARMSTRONG,WESTERMAN & HATTORI, LLP, 1725 K STREET, NW., SUITE 1000, WASHINGTON, DC, 20006, US

(73) Assignee: Fujitsu Limited, Kawasaki (JP)

(21) Appl. No.: 10/156,953

(22) Filed: May 30, 2002

Related U.S. Application Data
(63) Continuation of application No. PCT/JP99/07326, filed on Dec. 27, 1999.

(51) Int. Cl. G06F 15/173; G06F 15/16

(52) U.S. Cl. 709/223; 709/206

(57) ABSTRACT

In a printer connected to a network, a mail server, having an address inherent in the printer, for transmitting/receiving an electronic mail is arranged. The electronic mail received by the mail server is decoded by a mail process unit. When an electronic mail sentence includes a control instruction of power supply control related to the printer, a request for a report of printer supplies management information, a request for a report of an operation state check, updating of a firmware, maintenance, printing of an attached file, or the like, a process depending on the control instruction is executed.

### TECHNICAL FIELD

The present invention relates to a printer which is used so as to be connected to a network such as a LAN, a control method, and a computer readable recording medium which stores a printer control program and, more particularly, to a printer which can be controlled and instructed by using electronic mails, a control method, and a recording medium.

### BACKGROUND ART

In recent years, many network servers and many network printers are installed in offices, and network servers and network printers related to servers are required to be operated around the clock. However, the printers are not always used. On days of duty, the first user turns on a printer, and the last user turns off the printer before departure. Although the user turns off the printer and then leaves the office without any problem, the user often leaves the office without turning off the printer. At present, efficient use of energy is cried out. Waste of energy caused by leaving the power of the printer ON poses environmental problems. Therefore, when a user notices that forget to turn off the printer, the user must return to the office to turn off the printer. In particular, on Friday or a day before a holiday, the user must returns to the office inevitably. In addition, when a user wants to check the using states of printers and the using state of supplies for maintenance and management for printers, internal information of the printers must be checked. However, in a conventional method, a user goes to a position where a printer is installed to check the state of the printer, or requests and sends back requested information by a unique connection protocol using a leased line. For this reason, remote printer management cannot be easily performed.

### DISCLOSURE OF INVENTION

According to the present invention, there is provided a printer which simply and easily performs control of the power supply of a printer by using electronic mails and which can acquire internal information, a control method, and a computer readable recording medium which stores a printer control program.

According to the present invention, there is provided a printer which connected to a network including: a mail server, having an address inherent in the printer, for transmitting/receiving an electronic mail; and a mail process unit for decoding the electronic mail received by the mail server and for, when a control instruction related to the printer is included in an electronic mail sentence, executing a process depending on the control instruction. In this manner, the printer according to the present invention directly receives an electronic mail transmitted from outside to the printer and decodes the contents of a control instruction described in the received electronic mail to process the contents, so that required control, collection of information, or the like can be simply and easily performed by using the electronic mail on the basis of an external instruction.

In this case, the mail process unit decodes and executes at least one of a control instruction related to control of the power supply of the printer, a request for a report of printer supplies management information, a request for a report of a check of a printer operation state, a control instruction of updating and maintenance of a firmware, a print control instruction of an attached file, and the like. The mail process unit decodes a password in the electronic mail sentence, and a process depending on a control instruction in he electronic mail sentence is executed when coincidence of the passwords can be achieved, thereby assuring the security.

When the electronic mail sentence includes a power supply turn-off instruction, the mail process unit executes a turn-off process of the printer power supply when it is determined that the power supply can be turned off in a check of the state of the printer. For this reason, when the printer is managed such that the power supply of the printer is turned off to be set in an inactive state at midnight or on holidays, even though a final checker leaves the office without turning off the printer, the checker can turn off the power supply of the printer by issuing an electronic mail to the printer without going to the office. Power can be prevented from being wasted by leaving the power of the printer ON in an inactive state.

When a control instruction in an electronic mail sentence includes a request for information managed by the printer, the mail process unit forms an electronic mail sentence depending on the request information and returns a reply mail to a mail address designated by a mail transmitter. For this reason, when an operator wants to acquire accounting information, service life of supplies, and the like of the printer installed in a client office, the operator can acquire the requested information of the printer without going to the client office.

When a control instruction in an electronic mail sentence includes an emulation designation, and when a file related to emulation is attached to an attached file, the mail process unit emulates the attached file and performs a print process. For this reason, when the electronic mail sentence is transmitted such that print process data such as a Tiff file and a postscript is attached to the electronic mail sentence, the electronic mail sentence can be printed in advance. A message can be transmitted in place of a message made by a facsimile or the like.

When a control instruction in an electronic mail sentence includes a firmware update instruction, and when an attached file includes an update file of the firmware, the mail process unit updates the firmware of the printer on the basis of the data of the attached file. For this reason, an operator can easily perform a version-up operation of the firmware of the printer by transmitting an attached file of an electronic mail without going to a place where the printer is installed.

The mail process unit forms an electronic mail sentence serving as an execution result obtained by a control instruction in a received electronic mail sentence. A mail transmitter returns the electronic mail sentence to a mail address designated by the mail transmitter. For this reason, when a control instruction for a power supply turn-off operation, a file print operation, an updating operation, or the like is performed by an electronic mail, a process result obtained in the printer is returned to the mail transmitted with a reply mail, so that an operator can correctly know the result of the control instruction.

The mail process unit designates the presence/absence of a print process of the received electronic mail in advance. When the electronic mail includes a print instruction, the mail process unit receives the electronic mail and executes the print process of the electronic mail. In this manner, when the printer is set such that a print process is automatically performed in reception of the electronic mail, all electronic mails are presented as print outputs, a user can use the electronic mails without being aware of mail reception and without perform a special operation.

The mail process unit includes a mail storage unit for storing a transmitted/received electronic mail and a reception record and printing the electronic mail as needed. A mail server includes a mail address setting unit for setting a mail address for receiving an electronic mail.

The present invention also provide a control method of a printer connected to a network, wherein an electronic mail is received by a mail server having an address, the received electronic mail is decoded, and, when the electronic mail sentence includes a control instruction related to the printer, a process depending on the control instruction is executed.

Furthermore, the present invention provides a computer readable recording medium which stores a printer control program installed on a printer used to be connected to a network, wherein the printer control program includes: a mail server, having an address inherent in the printer, for transmitting/receiving an electronic mail; and a mail process unit for decoding the electronic mail received by the mail server and for, when an electronic mail sentence includes a control instruction related to the printer, executing a process depending on the control instruction. The details of the control method for a printer and the computer readable recording medium which stores a printer control program are the same as those of the device configuration.

### BRIEF DESCRIPTION OF DRAWINGS

FIGS. 1A, 1B and 1C are block diagrams showing the functions of a printer according to the present invention in a network connection state;

FIG. 2 is a schematic diagram of an appearance of a printer to which the present invention is applied.

FIG. 3 is a schematic diagram of a printer internal structure in FIG. 2;

FIG. 4 is a diagram for explaining a format of a transmission mail addressed to a printer used in the present invention;

FIG. 5 is a diagram for explaining a format of a printer return mail according to the present invention;

FIGS. 6A to 6F are diagrams for explaining commands used in a transmission mail addressed to the printer according to the present invention;

FIGS. 7A and 7B show a flow chart of control processes based on electronic mail reception of the printer according to the present invention;

FIG. 8 is a flow chart of a power supply turn-off process in FIG. 7A;

FIG. 9 is a flow chart of a printer information request process in FIG. 7A;

FIG. 10 is a flow chart of a print process of an attached data in FIG. 7B;

FIG. 11 is a diagram showing a command transmission sequence of a power supply turn-off process with electronic mails;

FIG. 12 is a diagram showing a command transmission sequence for requesting control information with electronic mails;

FIG. 13 is a diagram showing a command transmission sequence for updating a firmware with electronic mails;

FIG. 14 is a diagram showing a command transmission sequence for printing an attached file with electronic mails; and

FIGS. 15A and 15B is a diagram showing a command transmission sequence obtained by combining a plurality of control instructions with electronic mails.

### BEST MODE FOR CARRYING OUT THE INVENTION

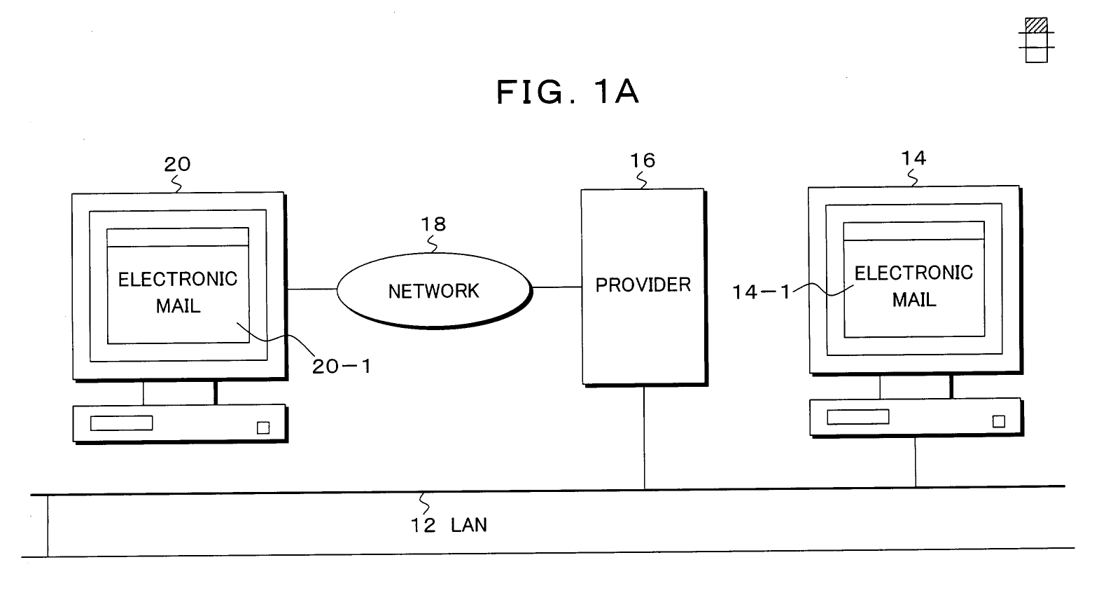

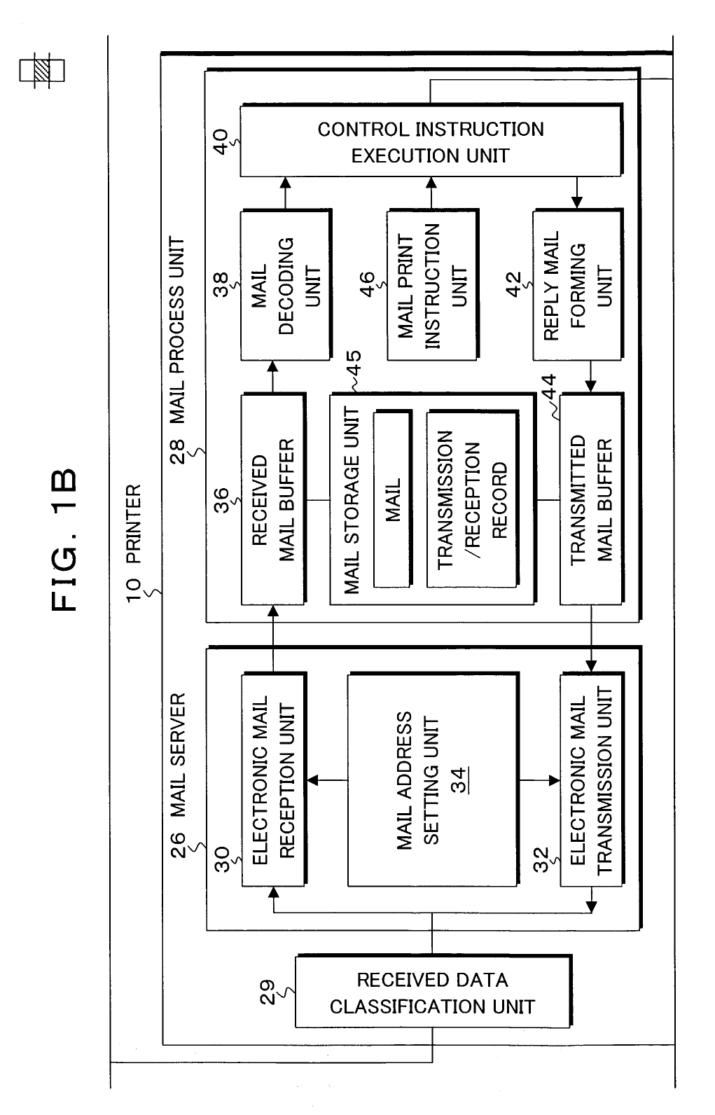

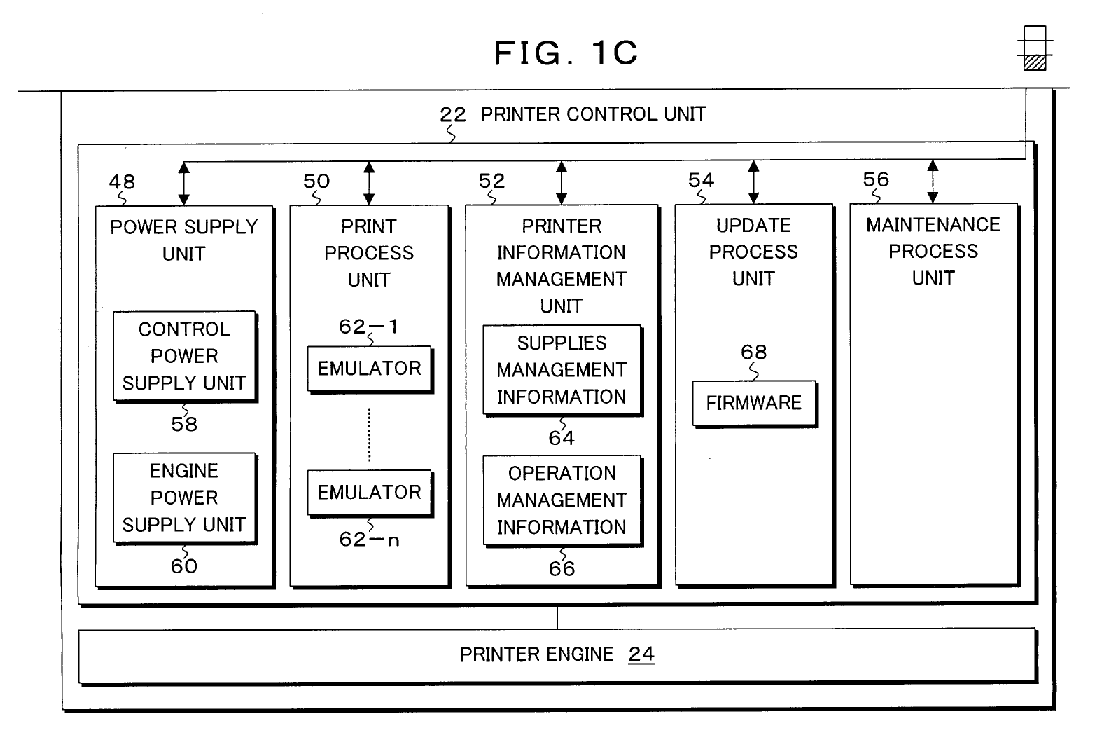

FIGS. 1A, 1B and 1C are block diagram showing a functional configuration of a printer according to the present invention in a network connection state. A printer 10 according to the present invention is connected to a LAN 12 together with a personal computer 14 in this embodiment. The LAN 12 is connected to a network 18 through a provider 16, and can communicate with an external personal computer 20 connected to the network 18. The network 18 includes a WAN, the Internet, or the like. A printer control unit 22 and a printer engine 24 are arranged in the printer 10. In addition, in the printer 10 according to the present invention, a mail server 26 and a mail process unit 28 are arranged. In the mail server 26, an electronic mail reception unit 30, an electronic mail transmission unit 32, and a mail address setting unit 34 are arranged. In the mail process unit 28, a reception mail buffer 36, a mail decoding unit 38, a control instruction execution unit 40, a return mail forming unit 42, a transmission mail buffer 44, a mail storage unit 45, and a mail print instruction unit 46 for setting printing of a reception mail. The mail server 26 has a mail address inherent in the printer 10, and exchanges electronic mails with the personal computers 14 and 20 serving as external clients connected to the printer through the LAN 12 or the network 18. Electronic mail applications 14-1 and 20-1 which are arranged in the personal computer 14 and 20 as clients, respectively, are realized by pieces of software called mailers. In the mailer, a destination mail address is input in an address column, a title and a text are input, and a transmission button is depressed. In this state, an electronic mail reaches a destination through a mail server. As a mail server which exchanges electronic mails between mailers, for example, an SMTP server is used. SMTP is an abbreviation of a Simple Mail Transfer Protocol. This protocol is used to exchange electronic mails between sites. The SMTP server stores electronic mails in a mail spool, and gives a mail to a client when the client inquires with the server. A protocol used when the server gives the electronic mail to the client is called POP. POP is abbreviation of a Post Office Protocol. The protocol is used when a client receives an electronic mail addressed to the client on the SMTP server. For this reason, in the electronic mail system, an SMTP server and a POP server are designated as settings of the mailers functioning as the electronic mail applications 14-1 and 20-1 of the personal computers 14 and 20. In the printer 10 of the present invention, the electronic mail reception unit 30 of the mail server 26 corresponds to the SMTP server, and the electronic mail transmission unit 32 corresponds to the POP server. A mail address inherent in the printer 10 is set by the mail address setting unit 34 in the electronic mail reception unit 30 serving as the SMTP server and the electronic mail transmission unit 32 serving as the POP server. When the electronic mail reception unit 30 receives an electronic mail addressed to the printer 10, the electronic mail reception unit 30 provides the received electronic mail to the mail process unit 28. The reception mail buffer 36 is arranged in the mail process unit 28, and holds an electronic mail received by the mail server 26 and addressed to the printer 10. The mail decoding unit 38 decodes the mail text of the received electronic mail. When the text includes a control instruction related to the printer, the mail decoding unit 38 transmits the control instruction to the control instruction execution unit 40 and executes a process depending on the control instruction. The printer 10 can print print data transmitted through the LAN 12. For this purpose, a reception data classification unit 29 for classifying data transmitted through the LAN 12 into normal print data and mails is arranged before the mail server 26. By using the reception data classification unit 29, when received data is normal print data, the print data may be classified to a print process unit 50. When the received data is a mail, the data may be classified to the mail server 26.

In this embodiment, as control instructions which can be performed, the followings are known.

(1) Control instruction of power supply control relations

(2) Request for report of management information of printer supplies

(3) Request for report of printer operation state

(4) Updating instruction of firmware

(5) Maintenance instruction of printer

(6) Print of attached file of electronic mail

In correspondence with the control instructions included in an electronic mail sentence, on the printer control unit 22 side, a power supply unit 48, a print process unit 50, a printer information management unit 52, an update process unit 54, and a maintenance process unit 56 are arranged. The power supply unit 48 has a control power supply unit 58 and an engine power supply unit 60. The power supply unit 48 can perform control to turn on/off any one or both of the control power supply unit 58 and the engine power supply unit 60. The power supply unit 48 is designated such that a mail power supply unit for supplying power to the mail server 26 and the mail process unit 28 is arranged to make it possible to turn on/off the control power supply unit 58 and the engine power supply unit 60 independently of the mail power supply unit. In this manner, the capacity of the mail power supply unit can be reduced, mails can be received around the clock, and a power consumption can also be suppressed. A plurality of emulators 62-1 to 62-n are arranged in the print process unit 50 to support emulation processes such as Tiff, postscript, G3-G4, PCL, HPGL, bitmap, and the like which are file forms of attached files. The process unit 50 converts an attached file into a bitmap file to output the bitmap file as a printer file. In the printer information management unit 52, supplies management information 64 and printer operation management information 66 of the printer 10 are stored. The update process unit 54 performs an update process for updating a firmware 68 installed on the printer 10 on the basis of the attached file of the electronic file. The maintenance process unit 56 rewrites the printer control information and forcibly rewrites a supplies counter value on the basis of the control instruction of the electronic mail. In addition, the maintenance process unit 56 copes with the process such as a request for trouble trace information in occurrence of trouble.

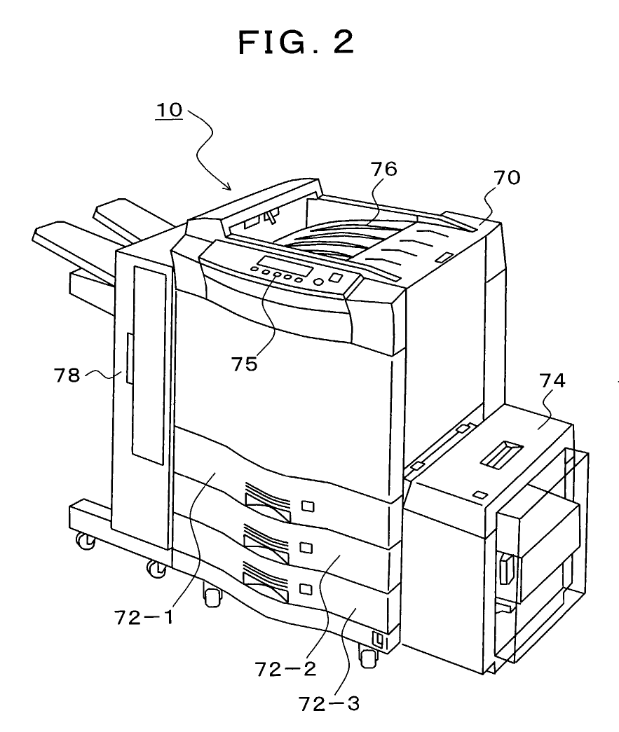

FIG. 2 is an appearance of the printer 10 according to the present invention shown in FIGS. 1A, 1B and 1C. In the printer 10, three paper trays 72-1, 72-2, and 72-3 are arranged at the lower section of a body 70, and a paper feed unit 74 which is an option which supplies a large number of sheets of paper is attached to the right end of the body 70. On the side opposing the paper feed unit 74, a sort unit 78 for sorting sheets of print paper is arranged. A sheet of paper supplied from the paper trays 72-1, 72-2, and 72-3 or the paper feed unit 74 is subjected to a print process by an electronic photographing recording system through the inside of the body 70 and then discharged to an upper stacker 76 or the sort unit 78. An operation panel 75 is arranged on an upper front section of the body 70. The operation panel 75 is used to make it possible to achieve, in addition to operational functions on a normal printer, settings required for processes of an electronic mail received by a mail server, e.g., a setting of a mail address by the mail address setting unit 34 arranged in the mail server 26 of the printer 10 in FIGS. 1A, 1B and 1C, designation of a print output of an electronic mail by the mail print instruction unit 46 arranged in the mail process unit 28, and the like.

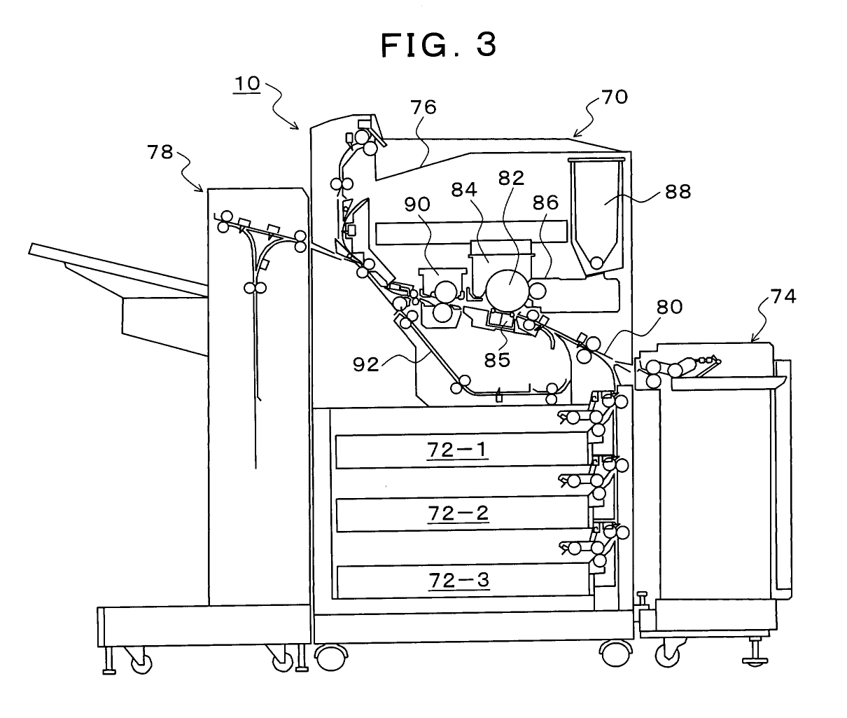

FIG. 3 is a schematic diagram showing the internal structure of the printer in FIG. 2. A sheet of paper drawn by a pickup roller from any one of the paper trays 72-1, 72-2, and 72-3 or the paper feed unit 74 arranged at the lower section of the body 70 is fed to an internal electronic photographing mechanism of the body 70 along a convey path 80. In the electronic photographing mechanism, a photosensitive drum 82, an exposure unit 84, a developing unit 86, and a transfer unit 85 are arranged. In an actual device, a pre-charger, the exposure unit 84, the developing unit 86, the transfer unit 85, and a toner cleaner are arranged around the photosensitive drum 82 in the order named. In order to simplify a description in this embodiment, the pre-charger and the toner cleaner are omitted. A recording operation of the electronic photographing mechanism will be described below. The exposure unit 84 flashes on/off an LED unit on the basis of image data (binary or multi-valued data), thereby writing an electrostatic latent image on the photosensitive drum 82 as a dot image. The electrostatic latent image written on the photosensitive drum 82 is electrostatically developed as an electrostatic toner image by the toner of the developing unit 86. Subsequently, the electrostatic toner image is electrostatically transferred on a sheet of paper sent through the convey path 80 by the transfer unit 85 located under the photosensitive drum 82. More specifically, charges having a polarity opposing that of the electrostatic toner image are given to the conveyed sheet of paper, thereby electrostatically transferring the electrostatic toner image on the photosensitive drum 82 onto the sheet of paper. Residual toner is on the surface of the photosensitive drum 82 upon completion of the transfer onto the sheet of paper. The residual toner is removed by the toner cleaner (not shown), and the removed residual toner is returned to a toner hopper 88 by a toner backflow device, and is used as developing toner again. A fixing unit 90 arranged after the transfer unit 85 has an upper heat roller and a lower heat roller. The sheet of paper passes through the fixing unit 90 such that the temperatures of the heat rollers are controlled to a fixing temperature by heating of heaters in the rollers, so that the toner is fixed on the sheet of paper. The sheet of paper passing through the fixing unit 90 is guided upward by a guide, and is discharged onto the stacker 76 or the sort unit 78. A convey path serving as a paper reversing loop 92 is arranged below the convey path 80 passing through the lower section of the photosensitive drum 82. When a sheet of paper passes through the paper reversing loop 92, images can be printed on both of the front and rear sides of the sheet of paper.

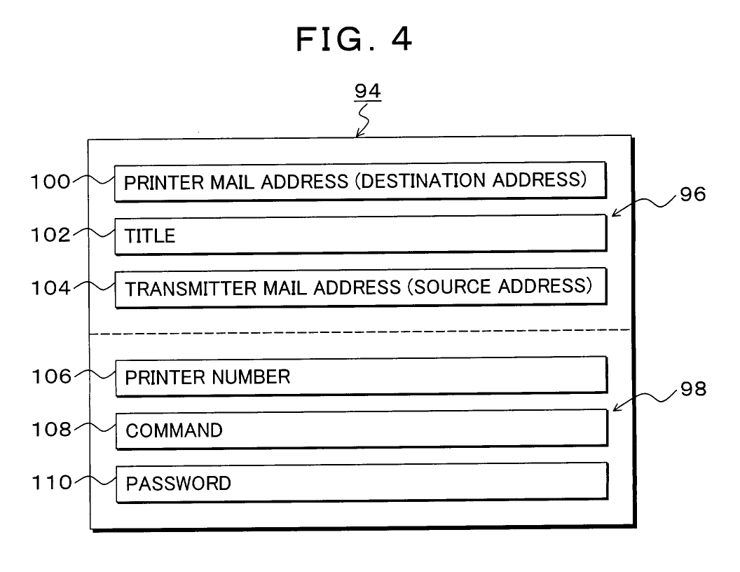

FIG. 4 is a diagram for explaining a format of a transmission mail which is addressed to a printer and transmitted from the personal computers 14 and 20 serving as clients to the mail server 26 of the printer 10 in FIGS. 1A, 1B and 1C. A printer-addressed mail 94 is constituted by a mail header 96 and a mail text 98. In the mail header 96, a printer mail address 100, a title 102, and a transmitter mail address 104 are set. The printer mail address 100 is a destination address of the electronic mail, and the transmitter mail address 104 is a source address of the electronic mail. In the mail text 98, a printer number 106, a command 108 for performing a control instruction, and a password 110 for security are set.

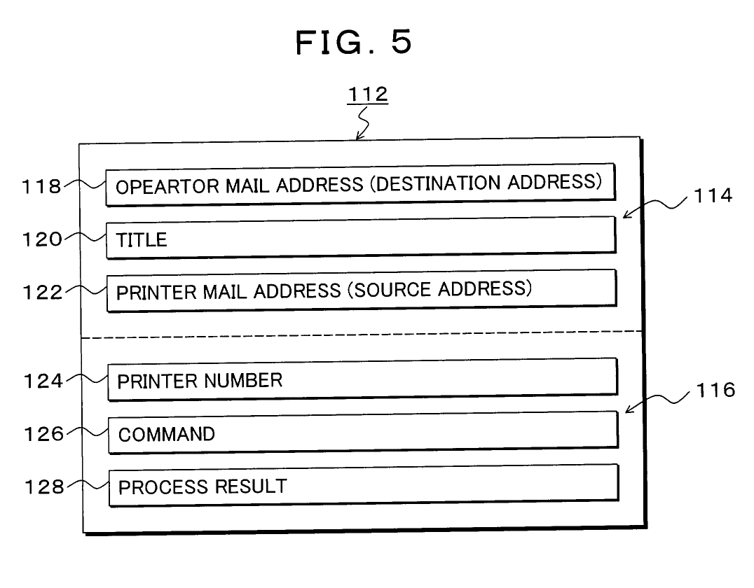

FIG. 5 shows a format of a printer return mail returned to an electronic mail source after the printer-addressed mail 94 in FIG. 4 is received by the printer 10 to execute a process based on a control instruction. A printer return mail 112 is constituted by a mail data 114 and a mail text 116. In the mail data 114, an operator mail address 118 serving as a destination address, a title 120, and a printer mail address 122 serving as a source address are set. In the mail text 116, a printer number 124, a command 126 which is a control instruction of a received electronic mail, and a process result 128 which is an execution result of the control instruction.

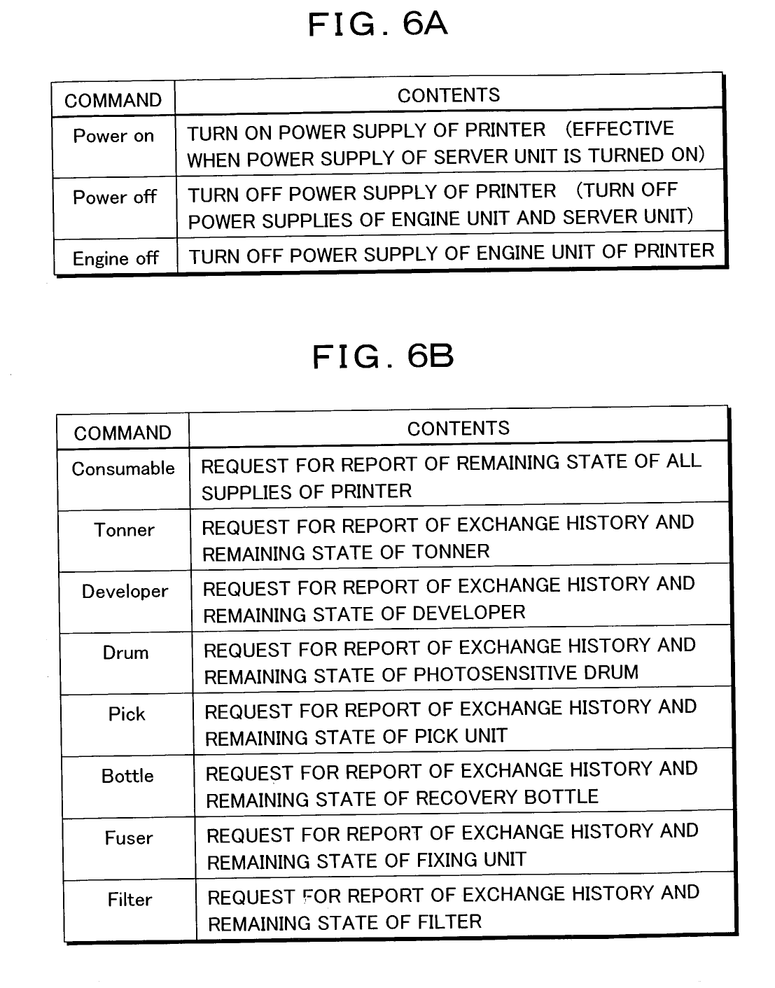

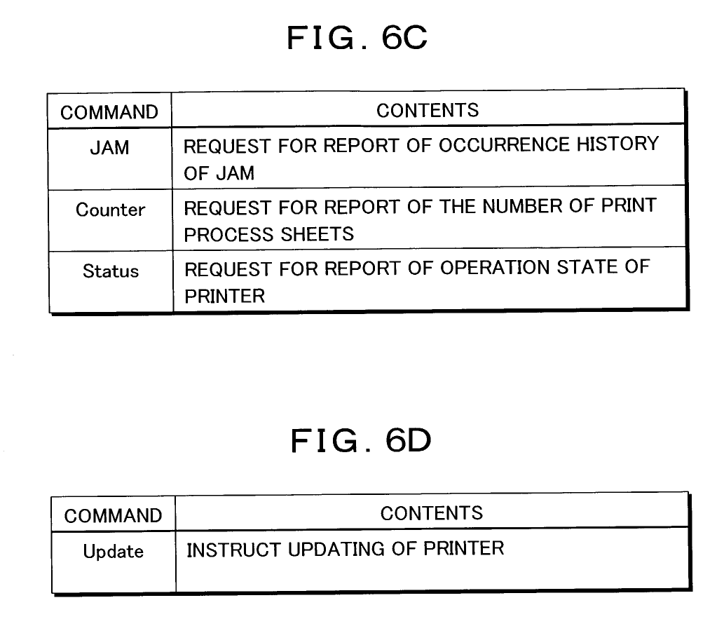

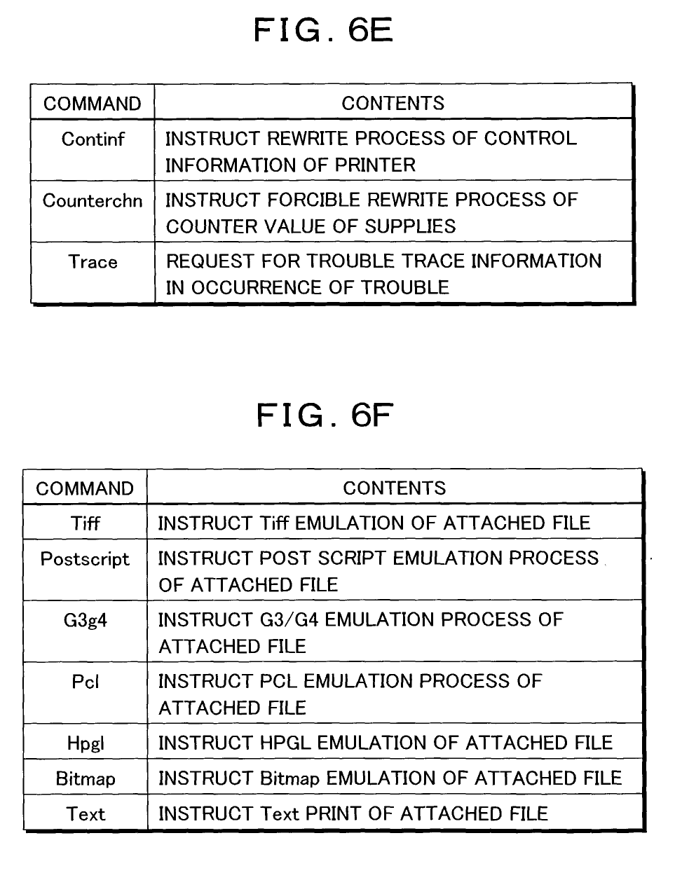

As commands serving as control instructions to the printer 10 written in the mail text 98 of the printer-addressed mail 94 in FIG. 4, for example, commands shown in FIGS. 6A to 6F. FIG. 6A shows commands related to power supply control of the printer. As the commands, three commands, i.e., “Power on”, “Power off”, and “Engine off” are prepared. The command “Power on” is valid when the power supplies of the mail server 26 and the mail process unit 28 in FIGS. 1A, 1B and 1C are in ON states, and turns on the power supplies of the printer control unit 22 and the printer engine 24. The command “Power off” is to turn off all the power supplies of the printer 10 including the mail server 26, the mail process unit 28, the printer control unit 22, and the printer engine 24. In addition, the command “Engine off” is to turn off the power supply of only the printer engine 24 of the printer 10. FIG. 6B shows printer supplies management information commands. As the commands, 8 types of commands, i.e., “Consumable”, “Toner”, “Developer”, “Drum”, “Pick”, “Bottle”, “Fuser”, and “Filter” are prepared. The commands are to request the reports of the remaining states of printer supplies, the exchange history and the remaining state of toner, the exchange history and the remaining state of a developer, the exchange history and the remaining state of a photosensitive drum, the exchange history and the remaining state of a pick unit, the exchange history and the remaining state of a recovery bottle, the exchange history and the remaining state of a fixing unit, and the exchange history and the remaining state of a filter. FIG. 6C shows printer operation state check commands. As the commands, three commands, i.e., “JAM”, “Counter”, and “Status” are prepared. The three types of commands are to request the reports of occurrence history of jams, the number of print process sheets, and a printer operation state. FIG. 6D shows an update command of a firmware. The command is to update the firmware of the printer by a command “Update”. FIG. 6E shows maintenance commands. The command “Continf” instructs a rewrite process of control information of the printer, and the command “Counterchn” is an instruction which forcibly rewrites the counter value of supplies, and the command “Trace” is a command which requests trouble trace information in occurrence of a trouble. FIG. 6F shows execution commands of a print file attached to an electronic mail. As these commands, commands “Tiff”, “Postscript”, “G3g4”, “Pc”, “Hpgl”, “Bitmap”, and “Text” are prepared. Of these commands, the commands except for the command “Text” instructs emulation processes for converting the respective data forms of the attached file into bitmap forms. Therefore, an emulator which can execute emulation processes of the data forms must be supported on the printer side.

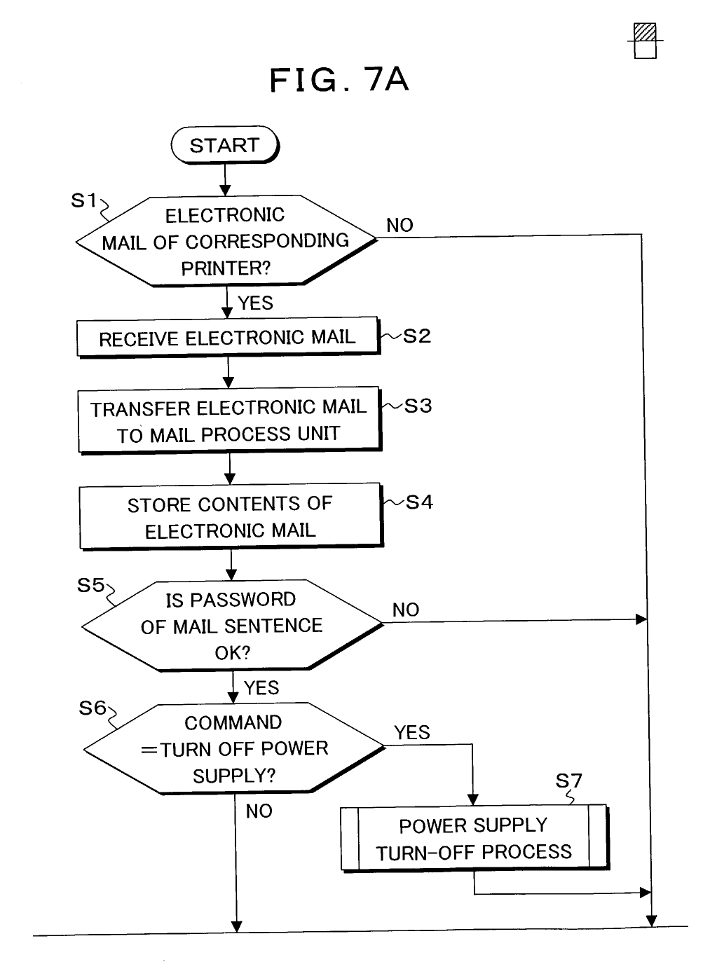

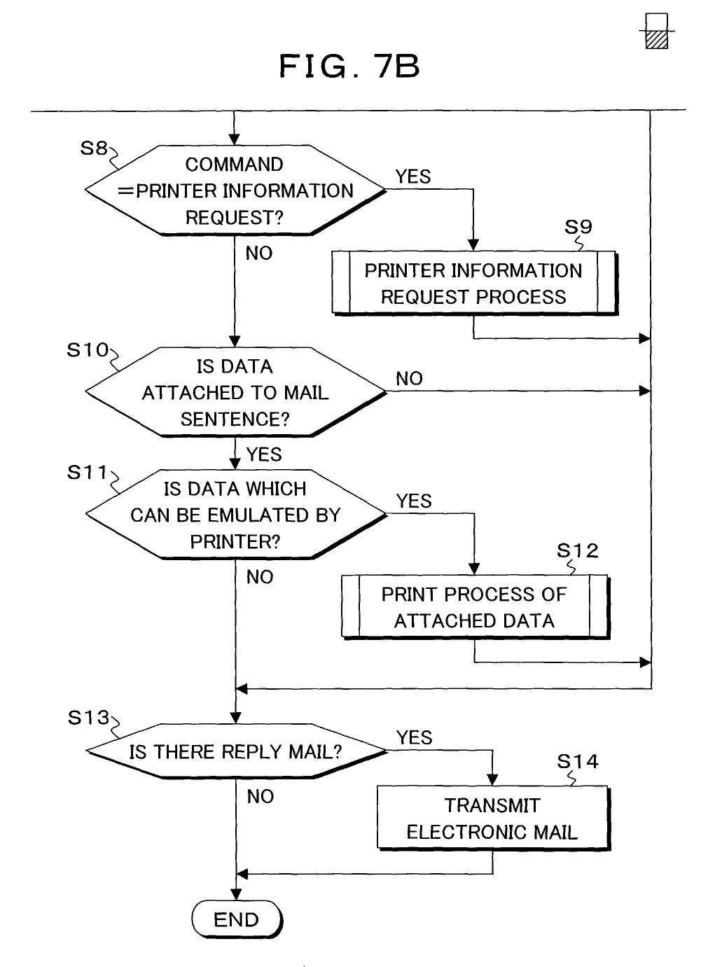

FIGS. 7A and 7B show a flow chart of control processes of the printer on the basis of reception of an electronic mail by the printer 10 according to the present invention in FIGS. 1A, 1B and 1C. In step S1, the presence/absence of reception of an electronic mail from the personal computer 14 or 20 serving as a client to the printer. When the electronic mail is received, the electronic mail reception unit 30 receives the electronic mail in step S2, and the electronic mail is transferred to the mail process unit 28 in step S3. In the mail process unit 28, the received mail is held in the reception mail buffer 36, and the received electronic mail is stored in the mail storage unit 45. Subsequently, in step S5, the mail decoding unit 38 extracts a password in the electronic mail sentence, compares and collates the password with a preset password. When coincidence of the passwords is achieved, the control flow shifts to step S6. In step S6, the command in the electronic mail sentence is decoded to check whether a turn-off operation of the power supply is instructed or not. When the turn-off operation of the power supply is instructed, the control flow shifts to step S7 to perform a power supply turn-off process. It is checked in step S8 whether the command in the electronic mail text is a request for printer information or not. When the command is the request for printer information, the control flow shifts to step S9, printer information designated by a command is acquired from the printer control unit 22, a return mail including requested printer information in the electronic mail text is formed by reply mail forming unit 42, and the return mail is transferred to the electronic mail transmission unit 32 of the mail server 26 through the transmission mail buffer 44 to be stored in the mail spool. IN step S10 in FIG. 7B, it is checked whether data is attached to the electronic mail text or not. When the data is attached, it is checked in step S11 whether the attached data can be subjected to emulation supported by the printer or not. The data can be subjected to the emulation, the control flow shifts to step S12 to execute a print process of the attached data. The control flow shifts to step S13 to check whether there is a return mail or not. If there is a return mail which is formed by the printer information request process in step S9, in step S14, the electronic mail is transmitted to the personal computer serving as a client which makes the request. The transmission process of the return mail in steps S13 and S14 is forcibly performed without an inquiry from the client such as a normal electronic mail, so that a result of a control instruction made by the electronic mail can be reliably transmitted to an operator. As a matter of course, when an inquiry is made by the client which is an operator without performing the transmission of the return mail in steps S13 and S14, the return mail from the electronic mail transmission unit 32 of the mail server 26 may be transmitted.

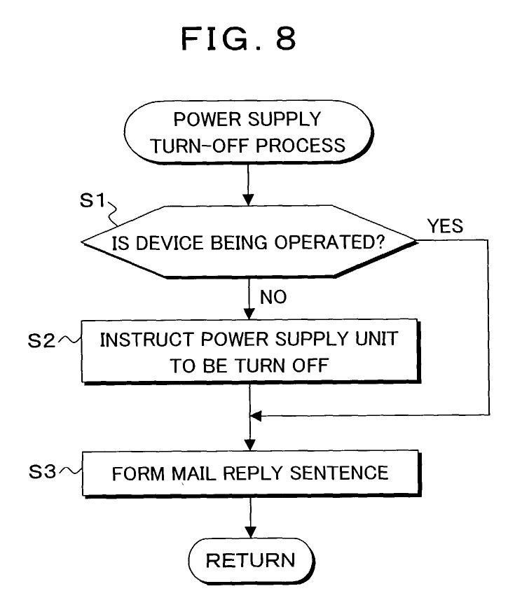

FIG. 8 is a flow chart showing the contents of a power supply turn-off process in step S7 in FIG. 7A. In this power supply turn-off process, it is checked in step S1 whether the printer 10 is active or not. When the printer 10 is not active, the control flow shifts to step S2 to transmit a turn-off instruction to the power supply unit 48. This turn-off instruction is a power supply turn-off instruction corresponding to any one of “Power off” and “Engine off” in FIG. 6A. In this manner, for example, when an operator leaves an office without turning off the printer 10, the operator can turn off the power supply of the printer 10 by transmitting an electronic mail from the outside. Therefore, the power supply of a printer installed at a distant place can be turned off by, e.g., a cellular mobile telephone, a mobile personal computer, or the like. When the execution of the turn-off operation of the power supply by the turn-off instruction is completed, a mail return sentence which includes a result of the turn-off instruction in the text is formed in step S3.

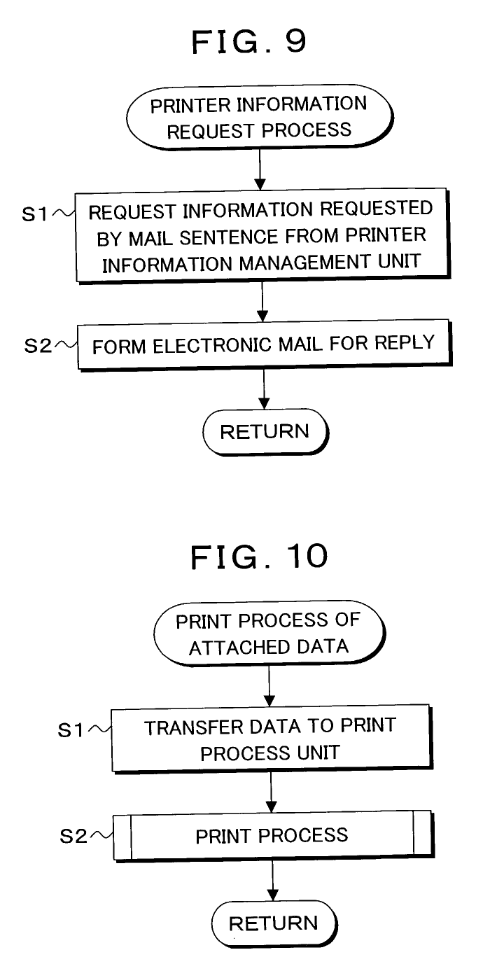

FIG. 9 is a flow chart showing the contents of a printer information request process in step S9 in FIG. 7A. In the printer information request process, information requested by a command of an electronic mail text is requested from the printer information management unit 52 in step S1, and an electronic mail for reply is formed in step S2.

FIG. 10 is a flow chart showing the contents of a print process of attached data in step S12 in FIG. 7A. In the print process of the attached data, data of an attached file attached to an electronic mail is transferred to the print process unit 50 of the printer control unit 22 in step S1, and file data is converted into drawing data by emulation using a corresponding emulator in step S2. A print process is executed by the printer engine 24.

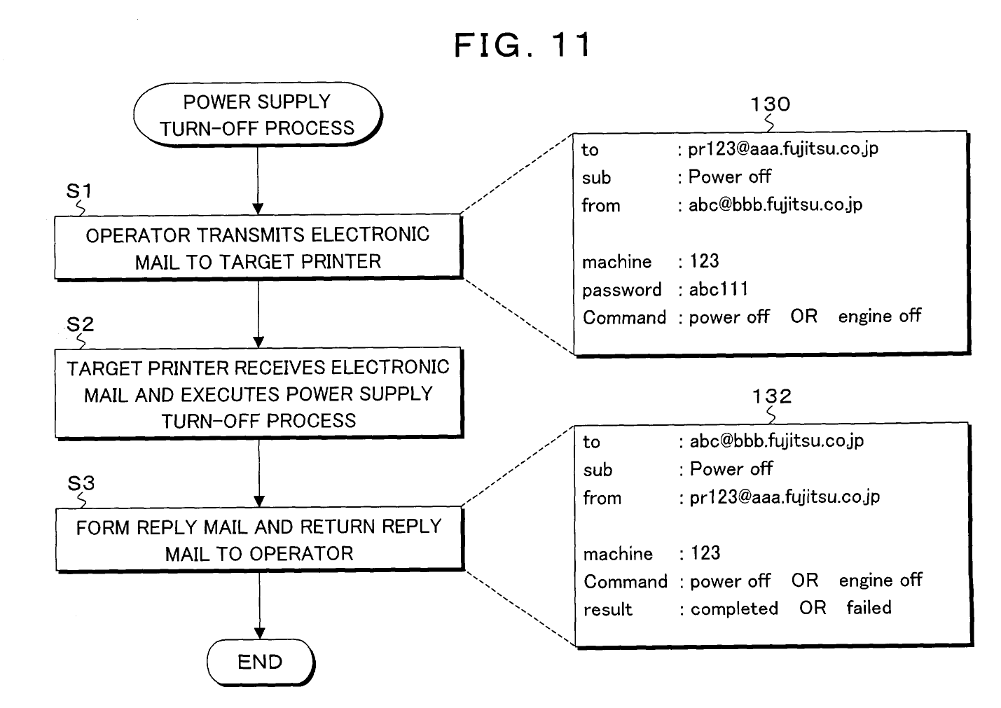

The sequence of a control instruction of the printer based on an electronic mail according to the present invention will be described below with a printer-addressed transmission mail and a printer return mail. FIG. 11 is a command sending sequence when a turn-off operation of the power supply of the printer is instructed by an electronic mail. In step S1, an operator uses the electronic mail application 20-1 of the external personal computer 20, i.e., a mailer to transmit an electronic mail to the printer 10 serving as a target. A printer-addressed electronic mail 130 formed at this time describes “pr123@aaa.fujitsu.co.jp” as a printer mail address “to” and describes, e.g., “Power off” as a title “sub”. Although any title maybe used, a title in English or Roman characters is basically used. However, when the mailer and the server cope with header coding of MIME form, a title in Japanese can also be described. In addition, As a transmitter mail address “form”, “abc@bbb.fujitsu.co.jp” is described. In the mail text, “123” is described as a printer number “machine”, and “abc111” is described as a password “password”. Furthermore, as a command “Command” for a power supply turn-off process, “power off” or “engine off” is described. In this manner, the printer-addressed electronic mail 130 formed in step S1 is transmitted to the printer, and the printer-addressed electronic mail 130 is received by a target printer in step S2. The power supply turn-off process is executed on the basis of the command. Upon completion of the power supply turn-off process, a return mail addressed to the operator is formed and returned in step S3. In the return mail 132, “abc@bbb.fujitsu.co.jp” is described as an operator mail address “from”, a title “sub” is “Power off” as in the transmission mail 130, and “pr123@aaa.fujitsu.co.jp” is described as a printer mail address “from”. In the subsequent mail text, “power off” or “engine off” is described as a command made by receiving a control instruction, and “complete” or “failed” is described as a process result “result”.

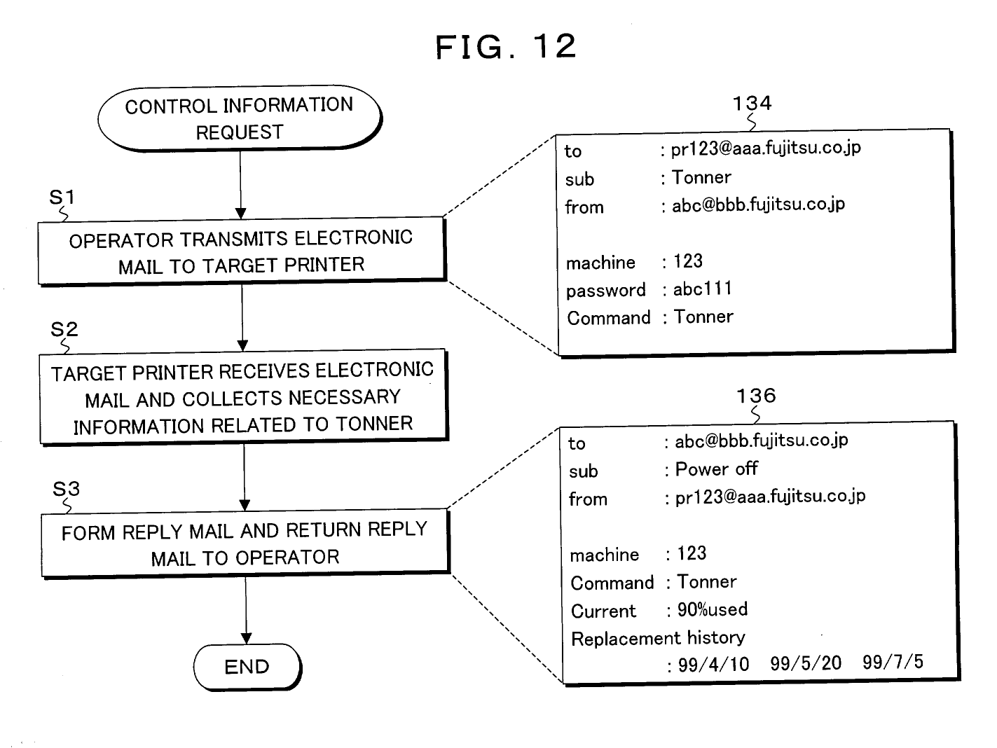

FIG. 12 shows a command sending sequence performed when an operator uses the external personal computer 20 to request printer control information from the printer 10 together with a transmission mail and a return mail. In step S1, the operator transmits an electronic mail 134 is transmitted to a target printer. In the electronic mail 134, a part of a command “Command” is “Toner” to the printer-addressed electronic mail 130 of a power supply turn-off process in FIG. 11. As is apparent from the printer supplies management information command in FIG. 6B, the command is a command which requests a report of the exchange history and the remaining state of toner. A target printer which receives the electronic mail 134 in step S2 collects required information related to the toner from the printer information management unit 52 of the printer control unit 22, forms a return mail 136, and returns the return mail 136 to the operator in step S3. In the return mail 136, “90% used” is described as a remaining state “Current”, and “99/4/10 99/5/20 99/7/5” is described as an exchange history “Replacement history”. In this manner, the operator knows the exchange history and the remaining state related to the toner of the printer on the basis of the return mail 136.

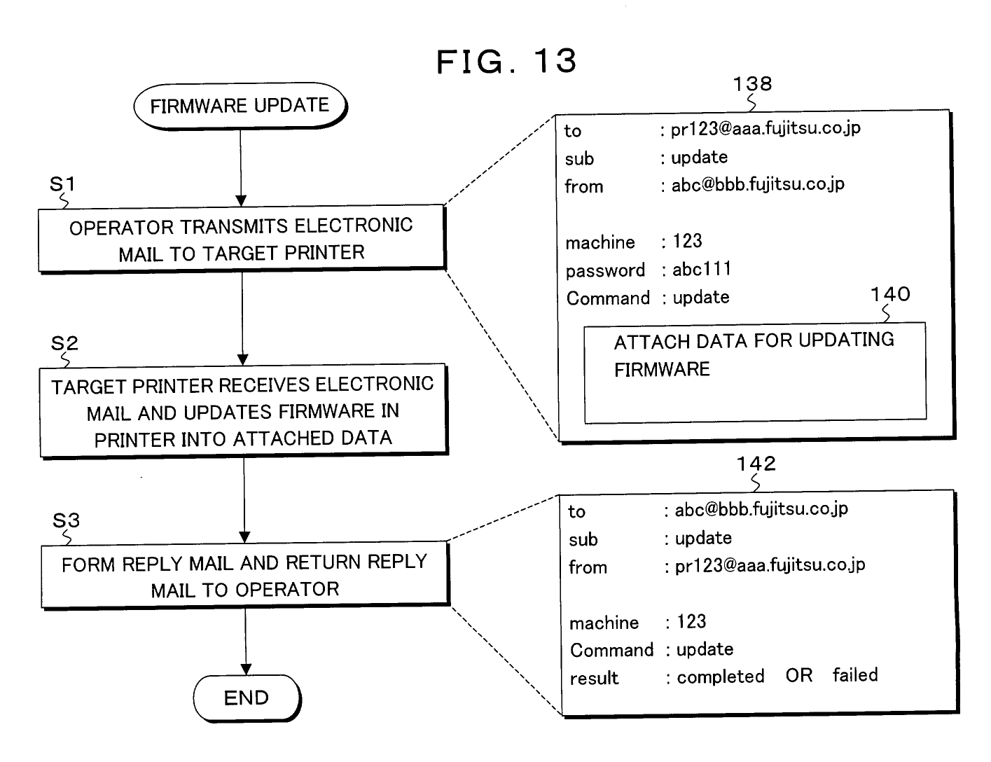

FIG. 13 is a command sending sequence performed when an operator uses the personal computer 14 or 20 in FIGS. 1A, 1B and 1C to update the firmware of the printer 10. In step S1, the operator transmits an electronic mail 138 to a target printer. In the electronic mail 138, “update” is described as a command “Command”, and data which updates the firmware is attached as an attached file 140. The target printer which receives the electronic mail 138 in step S2 executes an updating operation for updating the firmware 68 in the printer 10 into the attached data of the firmware attached to the electronic mail on the basis of the attached data of the electronic mail. In step S3, a return mail 142 is formed and returned to the operator. In the return mail 142, “update” is described as a command “Command”, and “completed” or “failed” is described as a process result “result”.

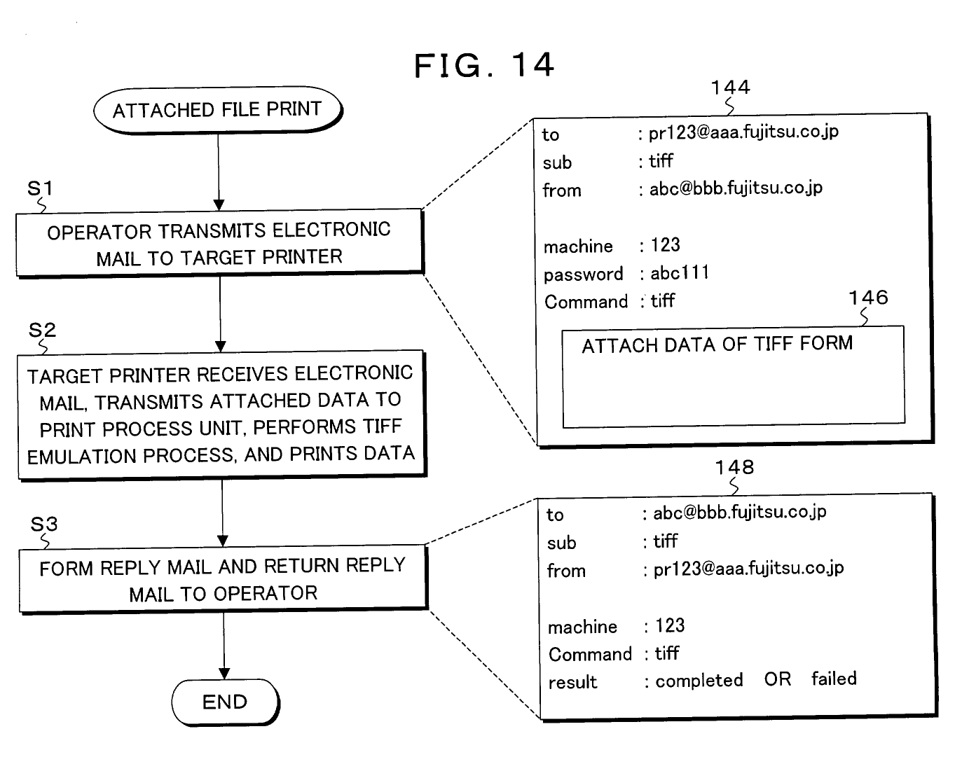

FIG. 14 shows a command sending sequence performed when the personal computer 14 or 20 in FIGS. 1A, 1B and 1C transmits an electronic mail together with an attached file and prints the attached file. In step S1, an operator transmits an transmission mail 144 to a target printer. The transmission mail 144 designates “tiff” as a command “Command” to instruct a Tiff emulation process of the attached file. The transmission mail 144 is attached with data of TIFF form as an attached file 146. The target printer which receives the transmission mail 144 transmits the attached data to the print process unit 50 in step S2, performs a TIFF emulation process to convert the data into dot data, and makes a print output operation. Upon completion of the print, in step S3, a return mail 148 is formed and returned in step S3. In the return mail 148, a command “Command” is “tiff”, and a process result “result” is one of “completed” and “failed”. Not only the attached data, but also the electronic mail sentence may be printed. In this case, only the text except for the password, the commands, and the like which need not be printed may be printed.

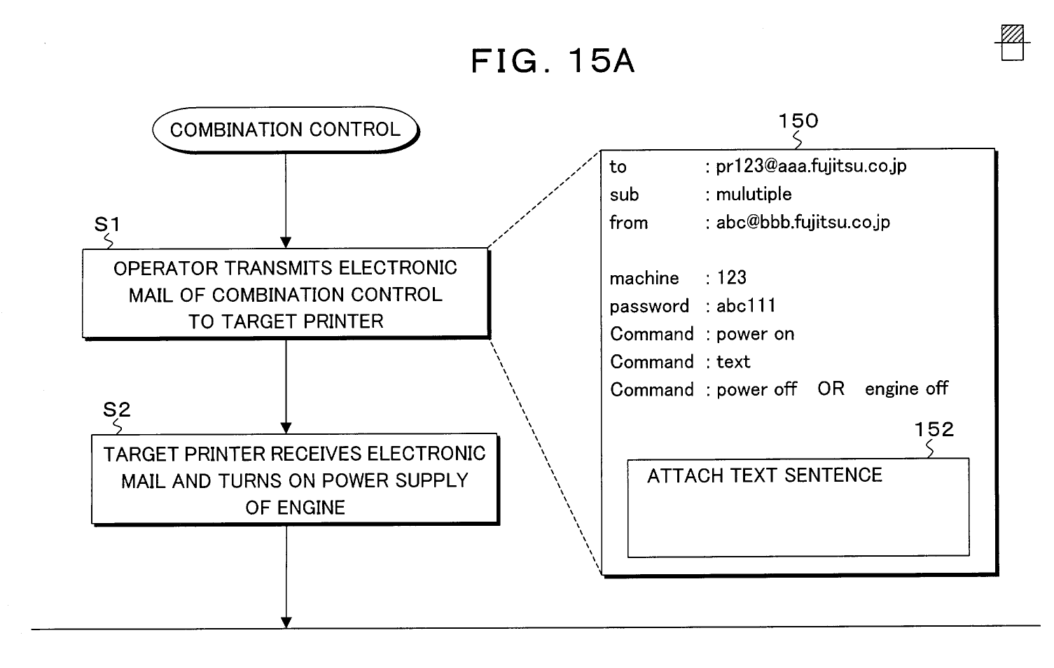

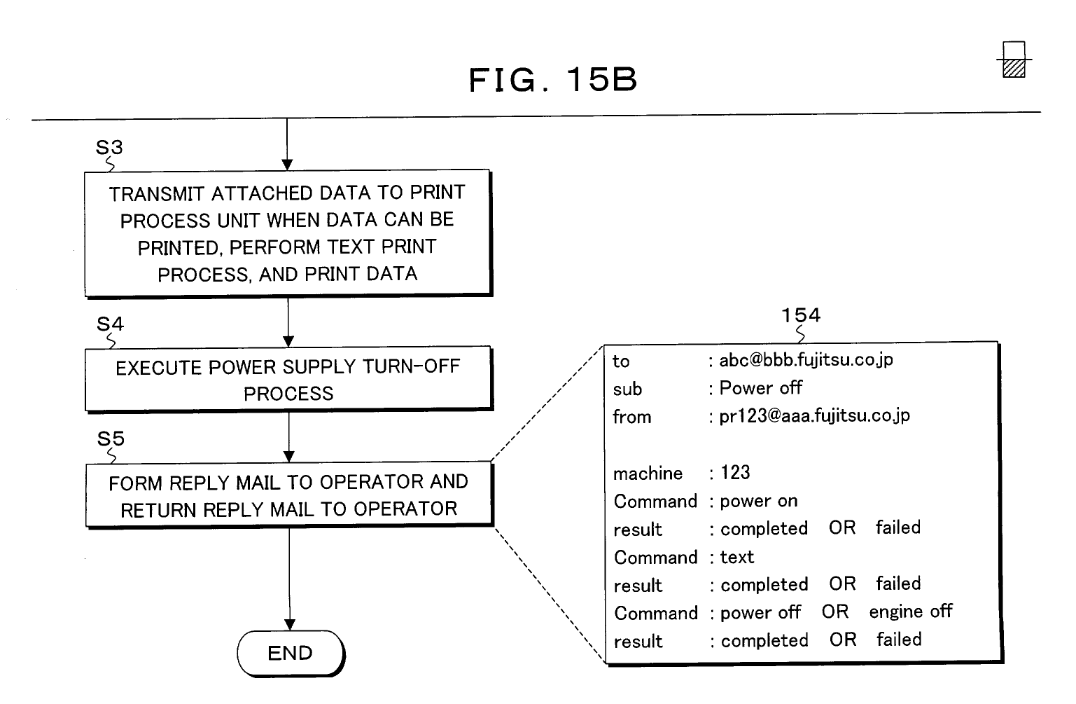

FIGS. 15A and 15B shows a command sending sequence performed when an electronic mail obtained by combining a plurality of control instructions is transmitted from the personal computer 14 or 20 in FIGS. 1A, 1B and 1C to the printer 10 and executed. In step S1, an operator transmits an electronic mail 150 for combination control to a target printer. In the electronic mail 150, as commands “Command”, “power on”, “text”, and “power off” or “engine off” are described. In addition, an attached file 152 of text form is attached to the electronic mail. The target printer which receives the electronic mail 150 turns on the power supply of the printer engine 24 on the basis of the first “power on” in step S2. In step S3, when the printer engine 24 can perform a print operation, the data of the attached file 152 is transmitted to the print process unit 50, a text print process for developing the data into drawing data is performed to print the drawing data. In step S4, a power supply turn-off process is executed on the basis of the command “power off” or “engine off”. Finally, in step S5, a return mail 154 is formed and returned to the operator. In the return mail 154, as a process result “result” of each of the three commands, “completed” or “failed” is described. In this manner, in a control instruction of the printer using an electronic mail according to the present invention, sequential sequence depending on a command string obtained by combining a plurality of commands can also be realized.

The functions of the mail server 26 and the mail process unit 28 arranged in the printer 10 in FIGS. 1A, 1B and 1C can be realized such that a printer control program having the functions of the mail server 26, the mail process unit 28, and the reception data classification unit 29 is installed on the printer 10 which can be connected to a network such as the LAN 12. Therefore, the present invention provides a computer readable recording medium such as a ROM, an MO, or a DVD which stores a printer control program serving as an application program having the functions of the mail server 26 and the mail process unit 28 and installed on the printer 10.

The printer control program serving as an application program which realizes the functions of the mail server 26 and the mail process unit 28 according to the present invention may be stored in a memory of a communication line or the printer 10 such that the printer control program is provided as a portable medium such as a RAM, an MO, or a DVD. The printer 10 and the server are connected to each other through the LAN 12 to constitute a printer system, and a printer control program having the functions of the mail server 26, the mail process unit 28, and the reception data classification unit 29 according to the present invention is installed on the server, so that the printer 10 may be operated on the basis of an instruction of the server. In this manner, a plurality of printers 10 can also be controlled by one server.

The present invention is limited to the above embodiments, and includes appropriate modifications without degrading the objects and the advantages. In addition, the present invention is not limited to numerical values shown in the above embodiments.

### INDUSTRIAL APPLICABILITY

As has been described above, according to a printer, a control method and a computer readable recording medium which stores a printer control program according to the present invention, an electronic mail transmitted from outside to the printer is directly received, and the contents of a control instruction written in the received electronic mail are decoded and processed, so that printer control required for an external instruction and collection of printer information can be simply and easily performed by using the electronic mail. For example, the printer is managed such that the power supply of the printer is turned off to be set in an inactive state at midnight or on holidays. In this case, even though a final user leaves the office without turning off the printer, the user finds that the printer is not turned off on his/her way home and transmits an electronic mail in which a power supply turn-off instruction is written to the printer, so that the user can turn off the power supply of the printer without going to the office. Therefore, power can be prevented from being wasted by leaving the power of the printer ON. When instructions related to the management, maintenance, and updating of the printer are performed from outside by using an electronic mail, the printer can easily cope with these instructions. In addition, when a print output of an electronic mail is used, the printer can be used in the same manner as that of a facsimile.

1. A printer connected to a network, comprising:
a mail server, having an address inherent in the printer, for transmitting/receiving an electronic mail; and
a mail process unit for decoding the electronic mail received by the mail server and for, when a control instruction related to the printer is included in an electronic mail sentence, executing a process depending on the control instruction.

2. The printer according to claim 1, wherein the mail process unit decodes and executes at least one of a control instruction related to control of the power supply of the printer, a request for a report of printer supplies management information, a request for a report of a check of a printer operation state, a control instruction of updating and maintenance of a firmware, a print control instruction of an attached file.

3. The printer according to claim 1, wherein the mail process unit decodes a password in the electronic mail sentence, and a process depending on a control instruction in the electronic mail sentence is executed when coincidence of the passwords can be achieved.

4. The printer according to claim 1, wherein, when the electronic mail sentence includes a power supply turn-off instruction, the mail process unit executes a turn-off process of the printer power supply when it is determined that the power supply can be turned off in a check of the state of the printer.

5. The printer according to claim 1, wherein, when a control instruction in an electronic mail sentence includes a request for information managed by the printer, the mail process unit forms an electronic mail sentence depending on the request information and returns a reply mail to a mail address designated by a mail transmitter.

6. The printer according to claim 1, wherein, when a control instruction in an electronic mail sentence includes an emulation designation, and when a file related to emulation is attached to an attached file, the mail process unit emulates the attached file and performs a print process.

7. The printer according to claim 1, wherein, when a control instruction in an electronic mail sentence includes a firmware update instruction, and when an attached file includes an update file of the firmware, the mail process unit updates the firmware of the printer on the basis of the data of the attached file.

8. The printer according to claim 1, wherein the mail process unit forms an electronic mail sentence serving as an execution result obtained by a control instruction in a received electronic mail sentence.

9. The printer according to claim 1, wherein the mail process unit designates the presence/absence of a print process of the received electronic mail in advance, and when the electronic mail includes a print instruction, the mail process unit receives the electronic mail and executes the print process of the electronic mail.

10. The printer according to claim 1, wherein the mail process unit comprises a mail storage unit for storing a transmitted/received electronic mail and a reception record and printing the electronic mail as needed, and
the mail server comprises a mail address setting unit for setting a mail address for receiving an electronic mail.

11. A control method of a printer connected to a network, wherein an electronic mail is received by a mail server having an address inherent in the printer, the received electronic mail is decoded, and, when the electronic mail sentence includes a control instruction related to the printer, a process depending on the control instruction is executed.

12. A computer readable recording medium which stores a printer control program installed on a printer used to be connected to a network, wherein
the printer control program comprises:
a mail server, having an address inherent in the printer, for transmitting/receiving an electronic mail; and
a mail process unit for decoding the electronic mail received by the mail server and for, when an electronic mail sentence includes a control instruction related to the printer, executing a process depending on the control instruction.
